(19) United States
(12) Patent Application Publication
(10) Pub. No.: US 2023/0126460 A1
(43) Pub. Date: Apr. 27, 2023

(54) SYSTEM AND METHOD FOR PREDICTING MACHINE FAILURE

(71) Applicant: Wayne State University, Detroit, MI (US)

(72) Inventors: Jeremy L. Rickli, Royal Oak, MI (US); Murat Yildirim, Macomb, MI (US); Mohamed Kilani, Pontiac, MI (US); Edward Kim, West Bloomfield, MI (US); Jeremy Epple, Macomb, MI (US)

(21) Appl. No.: 17/970,758

(22) Filed: Oct. 21, 2022

Related U.S. Application Data
(60) Provisional application No. 63/270,760, filed on Oct. 22, 2021.

(51) Int. Cl. G05B 23/02

(52) U.S. Cl. CPC G05B 23/0283; G05B 23/0272

(57) ABSTRACT

A system for predicting machine failure may include a controller for controlling a machine, a plurality of sensors, a plugin device, a first computing device, a second computing device, and/or a third computing device. The sensors and/or the plugin device may be communicatively coupled to the controller. The first computing device may be communicatively coupled to the plugin device. The plugin device may transmit data associated with the machine to the first computing device. The first computing device may execute at least one low fidelity model to determine an interesting event associated with the machine. The second computing device may be communicatively coupled to the first computing device. The first computing device may transmit data associated with the interesting event to the second computing device. The second computing device may execute at least one high fidelity model to determine a machine failure prediction.

### CROSS-REFERENCE TO RELATED APPLICATIONS

This application claims priority to U.S. Provisional Application No. 63/270,760 filed on Oct. 22, 2021, the contents of which is hereby incorporated by reference in its entirety.

### GOVERNMENT LICENSE RIGHTS

This invention was made with government support under grant no. 2054691 awarded by the National Science Foundation. The government has certain rights in the invention.

### TECHNICAL FIELD

The present disclosure generally relates to systems for predicating machine failure, which may be utilized in connection with manufacturing production lines and/or manufacturing assembly lines.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some systems for predicting machine failure do not provide sufficient functionality. Some systems are complicated, difficult to operate, inefficient, and/or not configured to effectively predict machine failures.

There is a desire for solutions/options that minimize or eliminate one or more challenges or shortcomings of systems. The foregoing discussion is intended only to illustrate examples of the present field and is not a disavowal of scope.

### SUMMARY

In embodiments, a method for predicting machine failure may include collecting data associated with a machine, inputting the data associated with the machine into at least one low fidelity model of a first computing device to determine an interesting event associated with the machine, transmitting, via the first computing device, data associated with the interesting event to a second computing device, inputting the data associated with the interesting event into at least one high fidelity model of the second computing device to determine a machine failure prediction, transmitting, via the second computing device, the machine failure prediction to a third computing device, and/or displaying, via the third computing device, the machine failure prediction.

With embodiments, a system for predicting machine failure may include a controller for controlling a machine, a plurality of sensors, a plugin device, a first computing device, a second computing device, and/or a third computing device. The plurality of sensors may be disposed proximate the machine. The sensors may be communicatively coupled to the controller. The plugin device may be communicatively coupled to the controller. The first computing device may be communicatively coupled to the plugin device. The plugin device may transmit data associated with the machine to the first computing device. The first computing device may execute at least one low fidelity model to determine an interesting event associated with the machine. The second computing device may be communicatively coupled to the first computing device. The first computing device may transmit data associated with the interesting event to the second computing device. The second computing device may execute at least one high fidelity model to determine a machine failure prediction. The third computing device may be communicatively coupled to the second computing device. The second computing device may transmit the machine failure prediction to the third computing device. The third computing device may display the machine failure prediction.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of a system for predicting machine failure according to teachings of the present disclosure.

FIG. 2A is a schematic view generally illustrating an embodiment of a computing device used in connection with the system for predicting machine failure according to teachings of the present disclosure.

FIG. 2B is a schematic view generally illustrating an embodiment of another computing device used in connection with the system for predicting machine failure according to teaching of the present disclosure.

FIG. 3 is another schematic view generally illustrating an embodiment of a system for predicting machine failure according to teachings of the present disclosure.

FIG. 4 is a flow diagram generally illustrating an embodiment of a method for predicting machine failure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, and networks have not been described in detail so as not to unnecessarily obscure aspects of the embodiments.

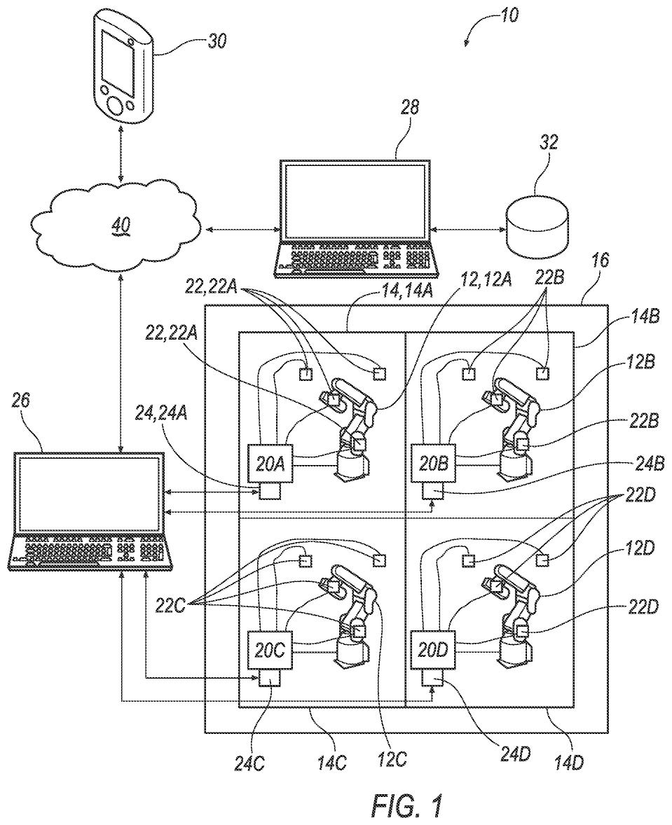

Referring to FIG. 1, a system 10 for predicting machine failure is illustrated. The system 10 includes a machine 12 that may be used in connection with a manufacturing production line and/or a manufacturing assembly line, among others. A machine 12 may compromise one or more of a variety of shapes, sizes, configurations, and/or materials. For example and without limitation, a machine 12 may include a robot, a device, tooling, and/or equipment, among others. A machine failure may include a machine downtime event such when the machine 12 is not operable and/or the machine 12 needs maintenance. The system 10 is configured to reduce unplanned machine downtime by predicting machine failures.

A machine 12 may be disposed within and/or may be used in connection with a manufacturing station 14. The manufacturing station 14 may be disposed within and/or may be used in connection with a manufacturing cell 16. As illustrated in FIG. 1, the manufacturing cell 16 may include a plurality of manufacturing stations such as a first manufacturing station 14A, a second manufacturing station 14B, a third manufacturing station 14C, and/or a fourth manufacturing station 14D. In some instances, each of the manufacturing stations 14A-14D may include a machine 12. For instance, a first machine 12A may be disposed within the first manufacturing station 14A, a second machine 12B may be disposed within the second manufacturing station 14B, a third machine 12C may be disposed within the third manufacturing station 14C, and a fourth machine 12D may be disposed within the fourth manufacturing station 14D. A manufacturing station 14 may comprise various additional tooling, machines, equipment, and/or robots, among others. The manufacturing cell 16 may include more or less than four manufacturing stations 14 and/or each of the manufacturing stations 14A-14D may include more than one machine 12.

With continued reference to FIG. 1, the system 10 further includes a controller 20, a plurality of sensors 22, a plugin device 24, a first computing device 26, a second computing device 28, and a third computing device 30.

A controller 20 is configured to control operation of a machine 12. A controller 20 may include a programmable logic controller (PLC). In some example configurations, each manufacturing station 14A-14D may include a controller 20. For instance, a first controller 20A may be disposed within the first manufacturing station 14A, a second controller 20B may be disposed within the second manufacturing station 14B, a third controller 20C may be disposed within the third manufacturing station 14C, and a fourth controller 20D may be disposed within the fourth manufacturing station 14D. The first controller 20A may be configured to control operation of the first machine 12A, the second controller 20B may be configured to control operation of the second machine 12B, the third controller 20C may be configured to control operation of the third machine 12C, and the fourth controller 20D may be configured to control operation of the fourth machine 12D. The system 10 may include more or less than four controllers.

A plurality of sensors 22 may be disposed within a manufacturing station 14. The sensors 22 may be disposed proximate a machine 12. At least some of the sensors 22 may be connected to the machine 12. The sensors 22 are communicatively coupled to a controller 20. The sensors 22 are configured to detect, sense, collect, and/or measure information (e.g., signals, data, inputs, etc.) associated with a machine 12, an environment surrounding the machine 12, a manufacturing station 14, and/or a manufacturing cell 16, among others. The sensors 22 are configured to transmit the information to the controller 20.

A sensor 22 may comprise one or more of a variety of shapes, sizes, configurations, and/or materials. For example and without limitation a sensor 22 may include an analog sensor, a digital sensor, a chemistry sensor, a composition sensor, a current sensor, a power sensor, an air quality sensor, a gas sensor, a Hall Effect sensor, a lightness level sensor, an optical sensor, a pressure sensor, a temperature sensor, an ultrasonic sensor, a proximity sensor, a motion tracking sensor, a humidity sensor and/or a camera, among others.

In some example configurations, the system 10 may include a first plurality of sensors 22A disposed within the first manufacturing station 14A and communicatively coupled to the first controller 20A, a second plurality of sensors 22B disposed within the second manufacturing station 14B and communicatively coupled to the second controller 20B, a third plurality of sensors 22C disposed within the third manufacturing station 14C and communicatively coupled to the third controller 20C, and/or a fourth plurality of sensors 22D disposed within the fourth manufacturing station 14D and communicatively coupled to the fourth controller 20D. The system 10 may include more or less than four pluralities of sensors.

A plugin device 24 may comprise one or more of a variety of shapes, sizes, configurations, and/or materials. A plugin device 24 may be communicatively coupled to a controller 20 and/or the first computing device 26. In some example configurations, the plugin device 24 may be connected to a controller 20 and/or may be disposed within a manufacturing station 14. In some instances, the plugin device 24 may be connected to the first computing device 26. The plugin device 24 may be disposed within and/or formed integrally with the first computing device 26. In some examples, the first computing device 26 may be configured to carry out the function of the plugin device 24. The plugin device 24 may include hardware and/or software. The plugin device 24 is configured to collect data associated with a machine 12 and/or a manufacturing station 14, among others. The plugin device 24 is configured to transfer the collected data to the first computing device 26. The collected data may include heterogeneous data. For instance, the collected data may include raw data captured from sensors 22, timestamped data, and/or operational parameter data (e.g., torque data, pass/fail data, etc.), among others.

In some configurations, the system 10 may include a first plugin device 24A communicatively coupled to the first controller 20A, a second plugin device 24B communicatively coupled to the second controller 20B, a third plugin device 24C communicatively coupled to the third controller 20C, and/or a fourth plugin device 24D communicatively coupled to the fourth controller 20D. The system 10 may include more or less than four plugin devices. For instance, the system 10 may include a single plugin device 24 that is used in connection with the entire manufacturing cell 16.

The first computing device 26 may be communicatively coupled to a controller 20, a plugin device 24, and/or the second computing device 28. The first computing device 26 may be disposed proximate the manufacturing cell 16. In some example configurations, the first computing device 26 includes an edge computing device. The first computing device 26 may include a computer, a laptop, and/or a desktop, among others. The first computing device 26 is configured to analyze, manipulate, and/or process data/information received from the controller 20, the plugin device 24, and/or the sensors 22. The first computing device 26 is configured to transmit data/information to the second computing device 28.

The second computing device 28 is communicatively coupled to the first computing device 26, an archive/database 32, and/or the third computing device 30. In some implementations, the second computing device 28 is communicatively coupled to the first computing device 26 and/or the third computing device 30 via a network 40 (e.g., a cloud server). The second computing device 26 includes a remote computing device. For instance, the second computing device 26 may be disposed at a location that is not disposed proximate the manufacturing cell 16. The second computing device 28 may include a computer, a laptop, and/or a desktop, among others. The second computing device 26 is configured to analyze, manipulate, and/or process the data/information received from the first computing device 28.

The third computing device 30 is communicatively coupled to the second computing device 28 via the network 40. In some implementations, the third computing device 30 includes a user device such as a cell phone, a computer, a laptop, a desktop, and/or a tablet, among others. The third computing device 30 is configured to display data/information received from the second computing device 28.

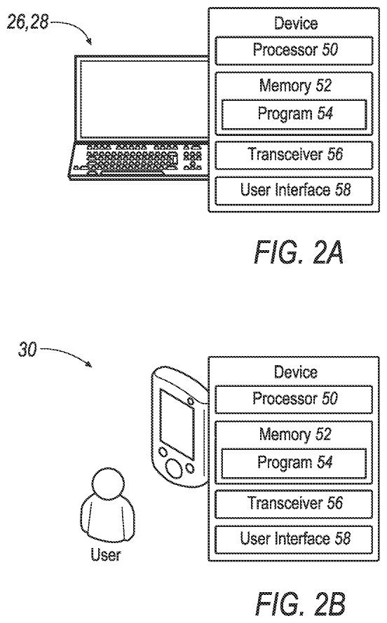

Referring to FIGS. 2A and 2B, the first computing device 26, the second computing device 28, and/or the third computing device 30 may each include a processor 50, a memory 52, at least one program 54, a transceiver 56, and/or a user interface 58. The processor 50 may include a hardware processor that executes the program 54 stored in the memory 52 to provide any or all of the operations described herein.

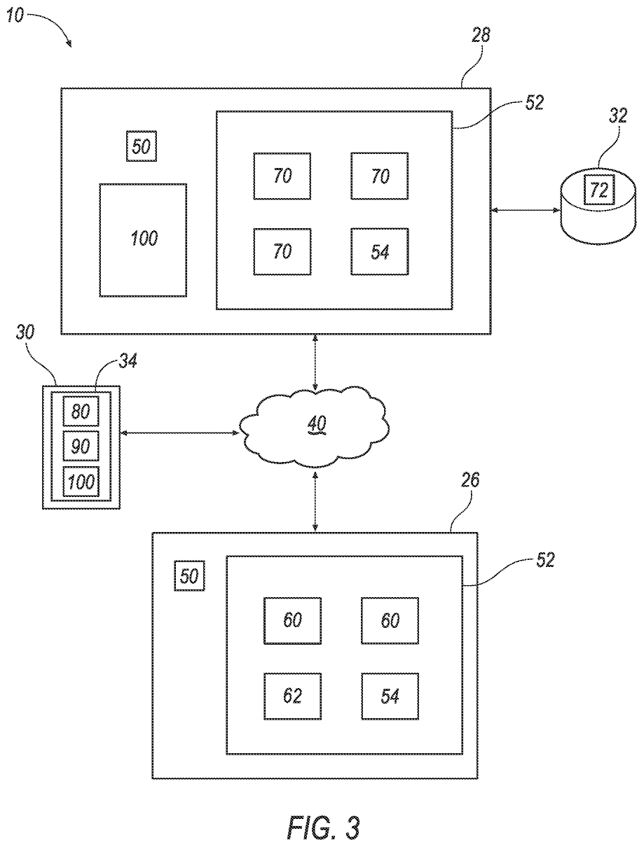

Referring now to FIG. 3, the system 10 is configured to utilize machine learning to determine a machine failure prediction associated with a manufacturing station 14 and/or a machine 12, among others. The system 10 is configured to execute various machine learning tasks, machine learning algorithms, and/or machine learning models to determine the machine failure prediction. In some example configurations, the system 10 utilizes unsupervised learning.

The first computing device 26 is configured to learn cell level behavior (e.g., behavior associated with a manufacturing cell 16), station level behavior (e.g., behavior associated with a manufacturing station 14 and/or a machine 12), and/or task level behavior (e.g., behavior associated with operations in a manufacturing station 14).

In some examples, the plugin device 24 receives and/or collects a continuous flow of real time data from the sensors 22, and the plugin device 24 transmits the continuous flow of data to the first computing device 26. The continuous flow of data may include raw data. The first computing device 26 receives a large amount of data from the plugin device 24.

In some implementations, the first computing device 26 is configured to input the data received from the plugin device 24 into at least one local adaptive model 62 to determine which received data is unnecessary data (e.g., not required for predicting machine failure, etc.) and the first computing device 26 is configured to eliminate (e.g., delete) the unnecessary data. The local adaptive model 62 may be stored within the memory 52 of the first computing device 26.

The first computing device 26 is configured to input the remaining data received from the plugin device 24 (e.g., data not deleted via the local adaptive model 62) into at least one low fidelity model 60 and the first computing device 24 is configured to execute (e.g., via processor 50 and/or program 54) the low fidelity model 60 to determine an interesting event associated with a manufacturing station 14 and/or a machine 12, among others. The low fidelity model 60 may be stored within the memory 52 of the first computing device 26.

For example and without limitation, an interesting event may include an anomaly event associated with operation of a manufacturing station 14 and/or a machine 12, among others. In some examples, the first computing device 26 (e.g., via the low fidelity model 60) is configured to determine a first pattern and a second pattern associated with performance of a manufacturing station 14 and/or a machine 12 and a deviation (e.g., an interesting event) between the first pattern and the second pattern. The first pattern may be associated with normal operation of a manufacturing station 14 and/or a machine 12 and the second pattern may be associated with abnormal operation of a manufacturing station 14 and/or a machine 12.

For instance, the first pattern may include a first torque that a component (e.g., a robot arm) of a machine 12 applies during normal operation of the machine 12. The second pattern may include a second torque that the component of the machine 12 applies during abnormal operation of the machine 12. The second pattern is different than the first pattern.

After the first computing device 26 determines an occurrence of an interesting event, the first computing device 26 is configured to transmit data associated with the interesting event to the second computing device 28. For example and without limitation, the data associated with the interesting event may include at least some of the data received from the plugin device 24 and/or an output of low fidelity model, among others. The amount of data (e.g., data associated with the interesting event) that the first computing device 26 transmits to the second computing device 28 is less than the amount of data the first computing device 26 receives from the plugin device 24.

The second computing device 28 is configured to input the data associated with an interesting event into at least one high fidelity mode 70 and the second computing device 28 is configured to execute (e.g., via processor 50 and/or program 54) the high fidelity model 70 to determine a machine failure prediction 80. The high fidelity model 70 may be stored within the memory 52 of the second computing device 28. A machine failure prediction 80 may include timing that a manufacturing station 14 and/or a machine 12 may experience a failure and/or need maintenance, among others. In some examples, the second computing device 28 receives computer-aided design (CAD) data associated with a manufacturing cell 16, a manufacturing station 14, and/or a machine 12, among others from a computing device. The second computing device 28 may utilize the CAD data in accordance with determining the machine failure prediction 80. The second computing device 28 is configured to transmit the machine failure prediction 80 to the third computing device 30. The third computing device 30 is configured to display (e.g., via a display 34) the machine failure prediction 80.

In some example configurations, the second computing device 28 is configured to transmit one or more alerts 90 to the third computing device 30. An alert 90 may include a root cause analysis associated with the abnormal operation of a manufacturing cell 16, a manufacturing station 14, and/or a machine 12 and/or a downtime risk, among others.

The second computing device 28 is configured to generate a digital twin 100 of a manufacturing cell 16, a manufacturing station 14, and/or a machine 12. For example and without limitation, the digital twin 100 may include a real-time virtual representation of a manufacturing cell 16, a manufacturing station 14, and/or a machine 12, among others. The third computing device 30 is configured to display at least a portion of the digital twin 100.

The second computing device 28 is configured to generate one or more high fidelity learned models 72 and the second computing device 28 is configured to store the high fidelity learned models 72 in the archive 32 (e.g., model archive). The second computing device 28 is triggered to generate a new high fidelity learned model 72 via the first computing device 28 determining an occurrence of an interesting event. The archive 32 is initially empty (e.g., at time zero). The second computing device 28 is configured to populate the archive 32 with a plurality of learned models 72.

In some implementations, the second computing device 28 (e.g., via high fidelity learned models 72) is configured to update the at least one low fidelity model 60 and the at least one local adaptive model 62 and/or generate additional low fidelity models 60 and local adaptive models 62 such that the first computing device 26 is configured to more effectively determine precedence, causality, and/or correlation of data received from the plugin device 24. The second computing device 28 is configured to update the at least one low fidelity model 60 and the at least one local adaptive model 62 and/or generate additional low fidelity models 60 and local adaptive models 62 such that the low fidelity models 60 and the local adaptive models 62 are able to process the data received from the plugin device 24 more efficiently.

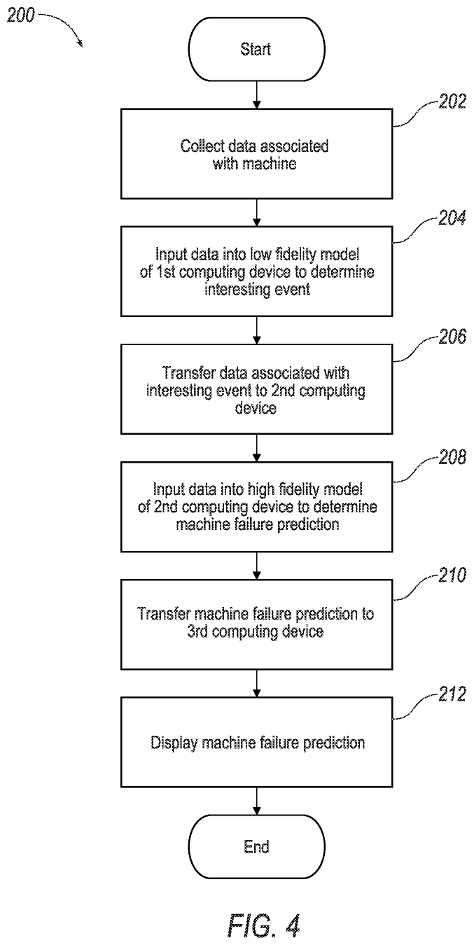

Referring to FIG. 4, a method 200 for predicting machine failure is illustrated. The method 200 includes collecting data associated with a machine 12 (block 202). For instance, a constant flow of real time data (e.g., heterogeneous data) from a plugin device 24, a controller 20, and/or a plurality of sensors 22 is transmitted to a first computing device 26. The first computing device 26 is disposed nearby the machine 12 and receives a large amount of data.

The method 200 includes inputting the data associated with the machine 12 into at least one low fidelity model 60 of a first computing device 26 to determine an interesting event associated with the machine 12 (block 204). For instance, the first computing device 26 is configured to process the large constant flow of data to determine an interesting event (e.g., a deviation from normal operation of the machine 12). In some examples, prior to inputting the data associated with the machine 12 into the at least one low fidelity model 60, the method 200 includes determining, via the first computing device 26, which of the received data is unnecessary data via inputting the data into at least one local adaptive model 62, and deleting the data determined to be unnecessary data. The first computing device 26 deletes the unnecessary data prior to executing the low fidelity model 60 to more quickly, efficiently, and/or effectively determine an interesting event.

The method 200 includes transmitting, via the first computing device 26, data associated with the interesting event to a second computing device 28 (block 206). For instance, the first computing device 26 filters a substantial majority of the received data and transmits interesting data that will undergo further processing via the second computing device 28. The second computing device 28 typically receives less data than the first computing device 26.

The method 200 includes inputting the data associated with the interesting event into at least one high fidelity model 70 of the second computing device 28 to determine a machine failure prediction 80 (block 208). The high fidelity model 70 is a more extensive model and requires more computing power to execute in comparison with the low fidelity model 60. Therefore, the second computing device 28 is typically a remote cloud computing device that is disposed at an external location and includes more computing power than the first computing device 26.

The method 200 includes transmitting, via the second computing device 28, the machine failure prediction 80 to a third computing device 30 (block 21) and displaying, via the third computing device 30, the machine failure prediction 80 (block 212). For instance, the third computing device 30 includes a personal user device such as a cell phone, etc. The user receives instant notification of the machine failure prediction 80 and, by receiving the notification, the user is afforded the opportunity to address the near term machine failure to eliminate any future unplanned machine downtime.

In examples, a computing device (e.g., plugin device 24, computing device 26, computing device 28, and/or computing device 30) and/or a controller (e.g., controller 20) may include an electronic processor, such as a programmable microprocessor and/or microcontroller. In embodiments, a computing device and/or a controller may include, for example, an application specific integrated circuit (ASIC). A computing device and/or a controller may include a memory (e.g., a non-transitory computer-readable storage medium) and/or an input/output (I/O) interface. A computing device and/or a controller may be configured to perform various functions, including those described in greater detail herein, with appropriate programming instructions and/or code embodied in software, hardware, and/or other medium. In embodiments, a computing device may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.”

As used herein, the term, optionally, construed to mean when” or “upon or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.”

It should be understood that a computing device (e.g., plugin device 24, computing device 26, computing device 28, and/or computing device 30) and/or a system 10 as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A method for predicting machine failure, the method comprising:
collecting data associated with a machine;
inputting the data associated with the machine into at least one low fidelity model of a first computing device to determine an interesting event associated with the machine;
transmitting, via the first computing device, data associated with the interesting event to a second computing device;
inputting the data associated with the interesting event into at least one high fidelity model of the second computing device to determine a machine failure prediction;
transmitting, via the second computing device, the machine failure prediction to a third computing device; and
displaying, via the third computing device, the machine failure prediction.

2. The method of claim 1, wherein:
the first computing device includes an edge computing device;
the second computing device includes a remote computing device; and
the third computing device includes a user device.

3. The method of claim 1, wherein:
the machine is used in connection with a manufacturing station;
the data associated with the machine includes heterogeneous data; and
the heterogeneous data includes timestamped data and parameter data.

4. The method of claim 1, wherein, prior to inputting the data associated with the machine into the at least one low fidelity model of the first computing device, the method includes:
determining, via the first computing device, which of the data associated with the machine is unnecessary data; and
eliminating, via the first computing device, the unnecessary data.

5. The method of claim 1, including determining, via the first computing device, a first pattern associated with performance of the machine.

6. The method of claim 5, including determining, via the first computing device, a second pattern associated with the performance of the machine.

7. The method of claim 6, including comparing, via the first computing device, the first pattern and the second pattern; and
wherein the interesting event includes a deviation between the first pattern and the second pattern.

8. The method of claim 1, including generating, via the second computing device, a digital twin of the machine; and
displaying, via the third computing device, at least a portion of the digital twin.

9. The method of claim 1, including generating, via the second computing device, a high fidelity learned model; and
storing, via the second computing device, the high fidelity learned model in a model archive connected to the second computing device.

10. The method of claim 9, wherein generating the high fidelity learned model is triggered via the first computing device determining an additional interesting event.

11. The method of claim 9, including updating, via the second computing device, the low fidelity model or generating an additional low fidelity model in connection with generating the high fidelity learned model.

12. The method of claim 9, including populating, via the second computing device, the model archive with a plurality of high fidelity learned models.

13. A system for predicting machine failure, comprising:
a controller for controlling a machine of a manufacturing station;
a plurality of sensors disposed proximate the machine, the sensors communicatively coupled to the controller;
a plugin device communicatively coupled to the controller;
a first computing device communicatively coupled to the plugin device, the plugin device transmits data associated with the machine to the first computing device, and the first computing device executes at least one low fidelity model to determine an interesting event associated with the machine;
a second computing device communicatively coupled to the first computing device, the first computing device transmits data associated with the interesting event to the second computing device, and the second computing device executes at least one high fidelity model to determine a machine failure prediction; and
a third computing device communicatively coupled to the second computing device, the second computing device transmits the machine failure prediction to the third computing device, and the third computing device displays the machine failure prediction.

14. The system of claim 13, wherein:
the first computing device includes an edge computing device disposed proximate the machine;
the second computing device includes a remote computing device that is not disposed proximate the machine, the second computing device is communicatively coupled to the first computing device via a cloud server; and
the third computing device includes a user device and the third computing device is communicatively coupled to the second computing device via the cloud server.

15. The system of claim 13, wherein, prior to the first computing device executing the at least one low fidelity to determine the interesting event, the first computing device determines which of the data associated with the machine is unnecessary data and the first computing device eliminates the unnecessary data.

16. The system of claim 13, wherein:
the first computing device determines a first pattern associated with performance of the machine;
the first computing device determines a second pattern associated with the performance of the machine; and
wherein the interesting event includes a deviation between the first pattern and the second pattern.

17. The system of claim 13, wherein the second computing device generates a digital twin of the machine; and
the third computing device displays at least a portion of the digital twin.

18. The system of claim 13, wherein the second computing device generates a high fidelity learned model via inputting the data associated with the interesting event into the at least one high fidelity model; and
the second computing device stores the high fidelity learned model in a model archive connected to the second computing device.

19. The system of claim 18, wherein generating the high fidelity learned model is triggered via the first computing device determining an additional interesting event.

20. The system of claim 18, wherein the second computing device populates the model archive with a plurality of high fidelity learned models.
